(19) United States
(12) Patent Application Publication
(10) Pub. No.: US 2004/0101051 A1
(43) Pub. Date: May 27, 2004

(54) Image processing apparatus and method for processing motion-picture data and still-image data

(75) Inventor: Yoshiki Ishii, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/705,938

(22) Filed: Nov. 13, 2003

(30) Foreign Application Priority Data
Nov. 22, 2002 (JP) 2002-339818

(51) Int. Cl. H04N 7/12

(52) U.S. Cl. 375/240.13; 375/240.03

(57) ABSTRACT

When an instruction for still image recording is input, input digital image data is stored as still-image data in a still image frame memory. A still-image recording control circuit changes over a switch so as to input the still-image data from the still image frame memory to a compression encoder circuit for a predetermined period of time, where the same still-image frames are continuously encoded. The still-image recording control circuit further controls a motion compensation prediction circuit so that motion compensation deliberately is not performed for still image recording to suppress the occurrence of motion vectors. The still-image recording control circuit also controls a quantization circuit so as to perform coding with a smaller quantization step for still image recording than for motion picture recording. In this manner, high-quality still image recording can be carried out even when the same coding scheme is used for both still image recording and motion picture recording.

### BACKGROUND OF THE INVENTION

1. Field of the Invention

The present invention relates to an image processing apparatus, and particularly to still-image processing performed in an image processing apparatus capable of compressing a motion picture using inter-frame coding, such as MPEG-1 or MPEG-2, for recording.

2. Description of the Related Art

Digital video (DV) recorders with an integrated camera capable of capturing, recording, and playing back motion pictures and still images are commercially available. In known consumer digital video recorders with an integrated camera, DV image data recorded onto a Mini DV cassette may be played back.

Such consumer digital video recorders with an integrated camera are able to record DV-compressed SD (standard definition) motion-picture data onto a tape medium, and also to record DV-compressed SD still-image data onto the tape medium for a certain period of time, in accordance with user instruction. Recording of still images together with predetermined search IDs allows a desired still image to be searched for (retrieved) on the tape medium based on the search ID during playback.

Recent studies have been focused on MPEG (Moving Picture Experts Group) HD (high definition) video recorders capable of recording motion-picture data onto a Mini DV cassette.

However, if DV-compressed SD still-image data is recorded onto a tape medium in the same manner in which MPEG-compressed HD video is recorded, problems occur. In particular, if the same video is recorded as MPEG still images for a certain time, the still-image sequence, which does not usually contain inter-frame differences caused by motion, has a problem in that use of the same inter-frame coding as used in motion picture recording causes a reduction in image quality at the beginning of the still-image sequence or mismatching between a variable-length code and an ID on each track. Therefore, high image quality and search performance inherent to still image recording are impaired.

### SUMMARY OF THE INVENTION

An object of the present invention is to overcome the above-described problems.

Another object of the present invention is to achieve high-quality still image recording when still images and motion pictures are recorded using the same coding scheme.

In one aspect, the present invention relates to an image processing apparatus for compressing input image data and outputting the compressed data, and includes a memory that stores input still-image data and outputs the stored still-image data continuously for a predetermined period of time, a compressing unit that compresses input motion-picture data or still-image data output from the memory continuously for the predetermined period of time using the same compression technique, and a controller that controls the compressing unit so as to compress the motion-picture data and the still-image data by different quantization processes.

In another aspect, the present invention relates to an image processing apparatus for compressing input image data and outputting the compressed data, and includes a memory that stores input still-image data and outputs the stored still-image data continuously for a predetermined period of time, a compressing unit that compresses input motion-picture data or still-image data output from the memory continuously for the predetermined period of time using at least an inter-frame coding compression technique, and a controller that controls a direction of prediction of the inter-frame coding in the compressing unit when the still-image data is compressed.

In another aspect, the present invention relates to an image processing apparatus for compressing input image data and outputting the compressed data, and includes a resolution converter that converts a resolution of the input image data, a memory that stores still-image data from image data output from the resolution converter and outputs stored still-image data continuously for a predetermined period of time, a compressing unit that compresses motion-picture data output from the resolution converter or still-image data output from the memory continuously for the predetermined period of time using at least an inter-frame coding compression technique, and a controller that activates the resolution converter when the motion-picture data is compressed, and deactivates or suppresses operation of the resolution converter when the still-image data is compressed.

In another aspect, the present invention relates to an image processing apparatus for compressing input image data and outputting the compressed data, and includes a memory that stores input still-image data and outputs stored still-image data continuously for a predetermined period of time, a compressing unit that compresses input motion-picture data or still-image data output from the memory continuously for the predetermined period of time using at least an inter-frame coding compression technique, and a controller that controls the compressing unit so as to compress the motion-picture data and the still-image data by different operations, wherein the compressing unit includes a quantization unit, and the controller controls the compressing unit so that the quantization unit uses a variable quantization characteristic value when the motion-picture data is compressed and uses a constant quantization characteristic value when the still-image data is compressed.

A recording apparatus of the present invention for compressing input image data and recording the compressed data includes a memory that stores input still-image data and outputs stored still-image data continuously for a predetermined period of time, a compressing unit that compresses input motion-picture data or still-image data output from the memory continuously for the predetermined period of time using at least an inter-frame coding compression technique, a recording unit that records motion-picture data or still-image data compressed by the compressing unit, and a controller that controls the compressing unit so as to perform different compression operations and controls the recording unit so as to perform different recording operations when the motion-picture data is recorded and when the still-image data is recorded.

According to the present invention, the amount of coding can be reduced when still-image data is inter-frame coded, and the reduced amount of coding can be utilized for improvement in image quality. Therefore, still images can be recorded with higher quality than motion pictures when the same coding scheme is used for both still image recording and motion picture recording.

Still other objects of the present invention, and the advantages thereof, will become fully apparent from the following detailed description of the preferred embodiments.

### BRIEF DESCRIPTION OF THE DRAWINGS

FIG. 1 is a block diagram of a digital video recorder according to embodiments of the present invention.

FIG. 2 is a detailed circuit diagram of an MPEG compression encoder circuit according to a first embodiment of the present invention.

FIGS. 3A and 3B are views showing a GOP, which is the unit of MPEG inter-frame coding, and the correlation of I-, P-, and B-pictures.

FIG. 4 is a view showing quantization characteristic values for video recording according to the first embodiment.

FIGS. 5A, 5B, 5C and 5D are views showing quantization matrices for video recording according to the first embodiment.

FIGS. 6A and 6B are views showing a closed GOP in MPEG coding.

FIG. 7 is a detailed circuit diagram of an MPEG compression encoder circuit according to a third embodiment of the present invention.

FIG. 8 is a detailed circuit diagram of an MPEG compression encoder circuit according to a fourth embodiment of the present invention.

FIG. 9 is a view showing a quantization characteristic value for still image recording according to the fourth embodiment.

FIGS. 10A and 10B are views showing the recording format of variable-length still-image data synchronized with still-image ID information.

### DESCRIPTION OF THE PREFERRED EMBODIMENTS

Preferred embodiments of the present invention will now be described in detail hereinafter with reference to the accompanying drawings.

First Embodiment

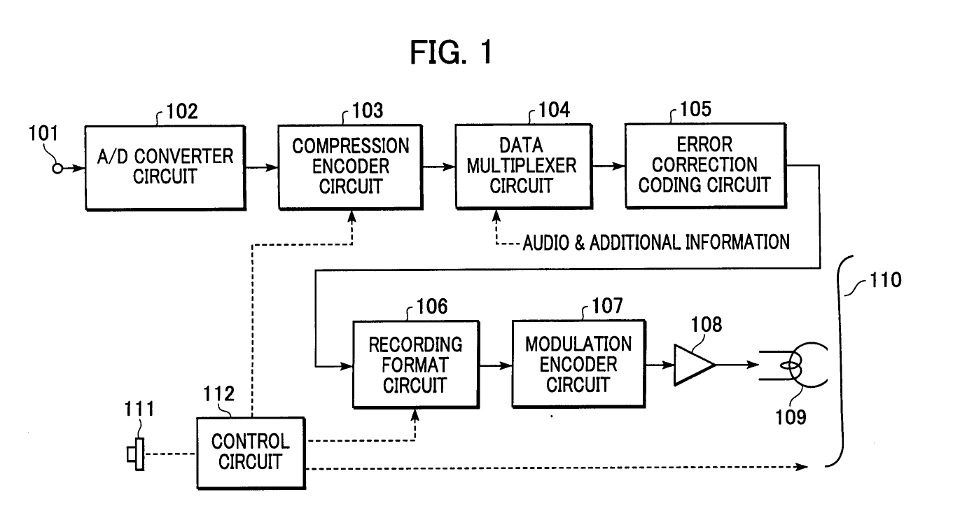

FIG. 1 schematically shows a digital video recorder, which is an image processing apparatus according to a preferred embodiment of the present invention. In FIG. 1, an input terminal 101 is connected to a camera unit or the like (not shown), and a video signal (a motion picture or a still image) captured by the camera unit or the like is input via the input terminal 101. The input video signal is converted into digital image data by an A/D (analog-to-digital) converter circuit 102.

The digital image data is compressed and encoded by a compression encoder circuit 103, and is multiplexed by a data multiplexer circuit 104 with audio data and additional information processed by a circuit (not shown). A detailed description of elements other than the image data, such as audio data and additional information, is well known by those skilled in the art, and therefore is omitted herein.

The data multiplexed by the data multiplexer circuit 104 is supplied to an error correction coding circuit 105, where parity information for error correction is added to the data. The data is supplied to a recording format circuit 106, where additional information including subcodes is further added to the data and the resulting data is converted (formatted) into the appropriate recording data format.

The formatted recording data is modulated by a modulation encoder circuit 107 into a recording-medium-compatible data stream. The modulated recording data is applied as an electrical signal to a recording head 109 via a recording amp 108, and is recorded onto a recording medium 110, such as an optical disk or a magnetic tape.

In the present invention, recording of a still image is instructed by a still image recording instruction input unit 111, and a control circuit 112 which receives this instruction generates a control signal for still image recording. The control signal for still image recording is supplied to a recording unit, which includes the recording head 109 and the recording medium 110, the compression encoder circuit 103, and the recording format circuit 106, in order to perform a still image recording process and operation. When a still image is recorded, ID information for identifying the still image recording is recorded in a subcode area which follows a video recording area where the still image is recorded. This allows still images to be searched for (retrieved) during playback, and facilitates index scanning of still images in a high-speed search operation. The ID information is generated in accordance with a control signal for still image recording, and is added to the recording data by the recording format circuit 106.

A detailed description of ID information to be recorded when a still image is recorded according to the present invention is now made. When the recording medium 110 is a magnetic tape, ID information for identifying still image recording (still-ID) is recorded in the manner shown in FIGS. 10A and 10B. FIG. 10A shows the position at which the still-ID added for every recording track is recorded, and FIG. 10B shows a recording format in which variable-length still-image data is synchronized with the still-ID. As depicted in the recording track format shown in FIG. 10A, each recording track is formed of a preamble area, a data area, a subcode area, a postamble area, and a margin area (shown as hatched). The image data is recorded in the data area, and the still-ID is recorded in the subcode area.

In the format shown in FIG. 10B, tracks are recorded across a tape from the left to right as the tape is fed to the left. Scanning of a recording head fixed to a rotating drum causes the tracks to be recorded from the bottom to the top. In FIG. 10B, motion-picture data finishes midway in the third track, and subsequent still-image data is recorded not on this track but on the next track, at the beginning thereof. On the third track, stuff (or fill) data is recorded in the remaining portion thereof. When a still-image data is recorded on the fourth track, the still-ID is recorded in the subcode area. Therefore, for high-speed searching while playing back only the subcode of the tape, the still-ID can be extracted so as to detect the recording start position of the still-image data and to detect the beginning of the still-image data.

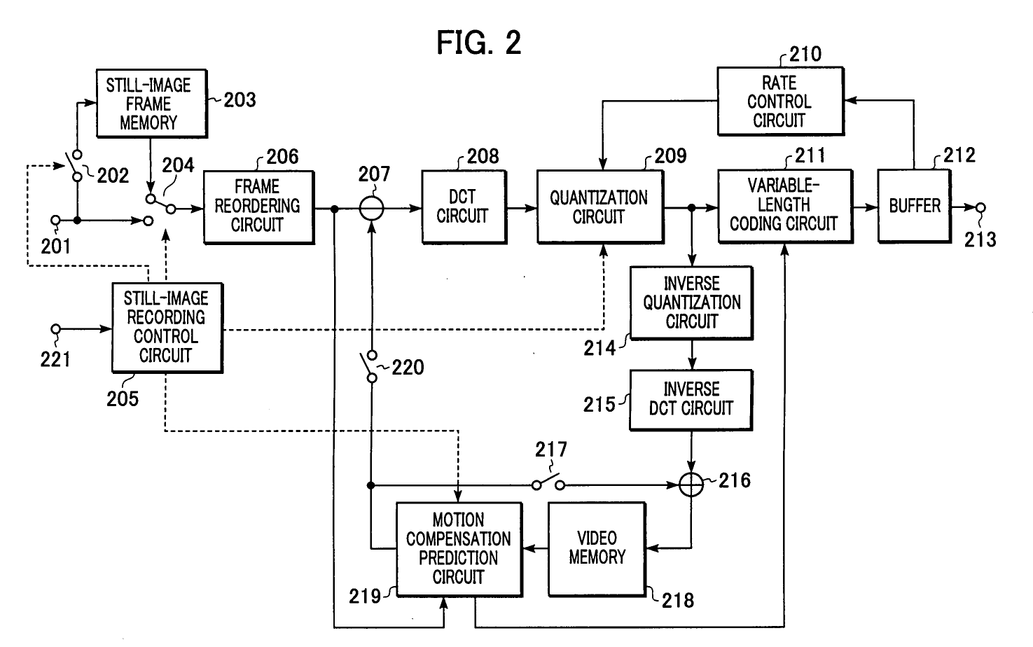

FIG. 2 shows the details of an MPEG compression encoder circuit 103 according to a first embodiment of the present invention.

The digital image data input to a terminal 201 may be motion-picture data or still-image data. Motion-picture data is applied to one input terminal of a switch 204. Still-image data is stored in a still-image frame memory 203 via a still-image hold switch 202, which operates in accordance with an instruction for still image recording, and is then supplied to the other input terminal of the switch 204.

The motion-picture data input from the switch 204 is supplied to a frame reordering circuit 206, where frames of the motion-picture data are rearranged according to the MPEG coding order. FIGS. 3A and 3B show a GOP (group of pictures), which is the unit of MPEG inter-frame coding, and the correlation of I-, P-, and B-pictures. FIG. 3A shows the pattern in which the frames of the input motion-picture data are arranged. In MPEG encoding, bi-directionally predictive frames, i.e., B-pictures, are reordered in the manner shown in FIG. 3B, and the data sequence is encoded. Accordingly, the frame reordering circuit 206 reorders the frames of the motion-picture data shown in FIG. 3A into the frames shown in FIG. 3B.

A frame difference circuit 207 takes the difference from inter-frame predicted data for the P-pictures and B-pictures via a switch 220.

A DCT (discrete cosine transform) circuit 208 converts the source image for the I-picture, and the prediction error image for the P-pictures and B-pictures into DCT coefficients.

A quantization circuit 209 performs quantization based on the product of a quantization matrix and a quantization characteristic value Q fed back from a rate control circuit 210. The quantized coefficients are entropy-coded by a variable-length coding circuit 211. The resulting values are passed through a buffer 212 for rate control, and are output from a terminal 213.

An inverse quantization circuit 214 inversely quantizes the quantized coefficients output from the quantization circuit 209. The resulting values are converted into pixel values by an inverse DCT circuit 215, and are added to the predicted images for the P-pictures and B-pictures by a frame adding circuit 216 by controlling a switch 217. The resulting image is stored in a video memory 218 as a locally decoded image.

The image stored in the video memory 218 is converted by a motion compensation prediction circuit 219 into a predictive image subjected to motion compensation with an input image to be predicted. This image is the predicted data for the P-pictures and the B-pictures used in the frame difference circuit 207.

When a control signal for still image recording is input to a terminal 221, a still-image recording control circuit 205 turns on the switch 202 so as to capture the digital image data in the still-image frame memory 203, and further connects the switch 204 to the still-image frame memory 203 for a predetermined period of time so as to input the same still-image frames read from the still-image frame memory 203 to the frame reordering circuit 206 and the following MPEG coding loop continuously for the predetermined period of time.

The MPEG coding process is carried out on both still-image data and motion-picture data in a similar way; however, the following control is performed for still-image data.

First, the still-image recording control circuit 205 controls the motion compensation prediction circuit 219 so that motion compensation deliberately is not performed for still image recording, to suppress or prohibit the occurrence of motion vectors (the motion vector is zero). This prevents an increased amount of coding due to unnecessary motion vectors between the inter-frame predicted image and the source image caused by a coding error even when the same frames are input.

The still-image recording control circuit 205 also controls the quantization circuit 209 so as to use a smaller quantization step for still image recording than for motion picture recording, so as to preserve high precision.

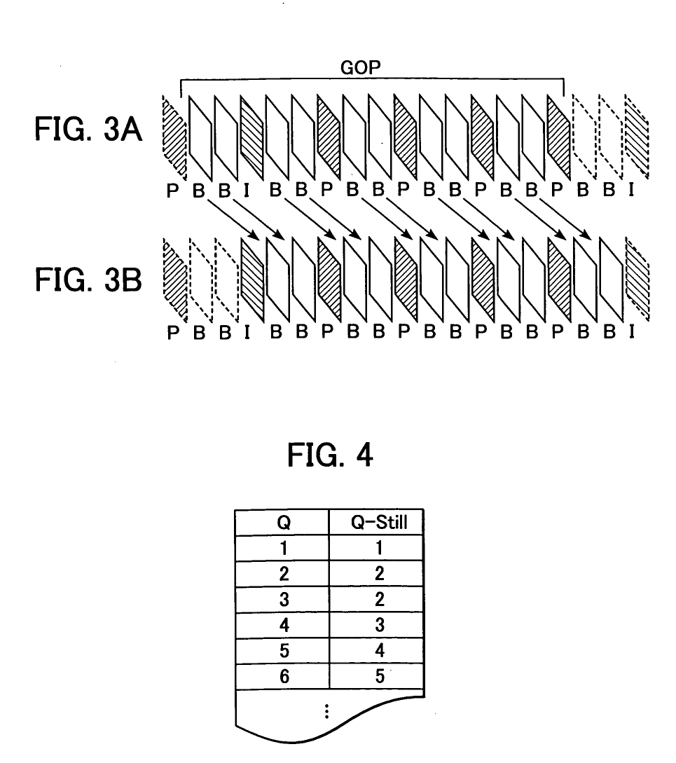

FIG. 4 shows an example of quantization characteristic values defined by rate control. A quantization characteristic value Q is used for motion picture recording. On the other hand, a quantization characteristic value Q-Still with a smaller step is used for still image recording, because still image recording only requires encoding for a coding error component of the I-picture for the B-pictures and P-pictures, resulting in sufficient room in the generated coding amount compared to motion picture recording which requires for coding the inter-frame differences for the B-pictures and P-pictures.

The Q-Still may be used for the B-pictures or the P-pictures whose prediction errors are coded. Otherwise, as described below, the Q-Still may be applied to the I-, P-, and B-pictures for a predetermined period of time.

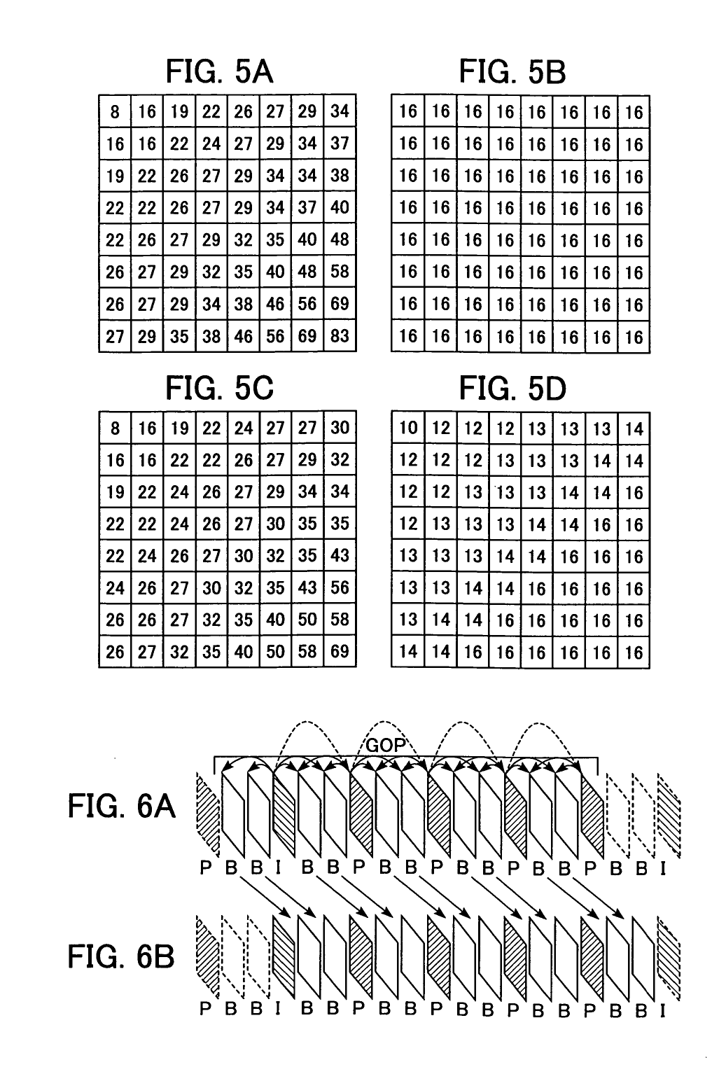

FIGS. 5A through 5D show quantization matrices with different quantization steps depending upon whether motion-picture data is recorded or still-image data is recorded. FIG. 5A shows a default matrix used for the I-pictures of motion-picture data, and FIG. 5B shows a default matrix used for the B-pictures and P-pictures of motion-picture data.

FIG. 5C shows a quantization matrix used for the I-pictures of still-image data, and FIG. 5D shows a quantization matrix used for the B-pictures and P-pictures of still-image data. In the still-image data, as described above, since the B-pictures and P-pictures represent the coding error of the I-pictures, a matrix reserving higher frequency components is used for the I-pictures, while the coding error is coded in the B-pictures and P-pictures with higher precision. Therefore, the still image can be recorded with high quality.

Second Embodiment

FIGS. 6A and 6B show the processing when the start GOP of a still-image sequence is a closed GOP. FIG. 6A shows the direction of prediction of the first B-picture in the closed GOP. In FIG. 6A, the B-picture is predicted, not bi-directionally from both the P-picture and the I-picture of the preceding GOP, but uni-directionally from the I-picture. FIG. 6B shows the B-pictures reordered for MPEG encoding.

In the coding scheme using the compression encoder circuit shown in FIG. 2 described above in the first embodiment, the start GOP is formed as a closed GOP under the control of the still-image recording control circuit 205 when recording still-image data. This prevents image degradation due to discontinuity at the beginning of the still-image sequence in addition to the advantage of the first embodiment.

In MPEG-2 coding, the picture structure of image data is fixed to a frame structure for still-image data, and frame prediction is carried out by the motion compensation prediction circuit 219. This provides the B-pictures and the P-pictures with high-efficiency prediction, thereby achieving high-quality still image recording.

Third Embodiment

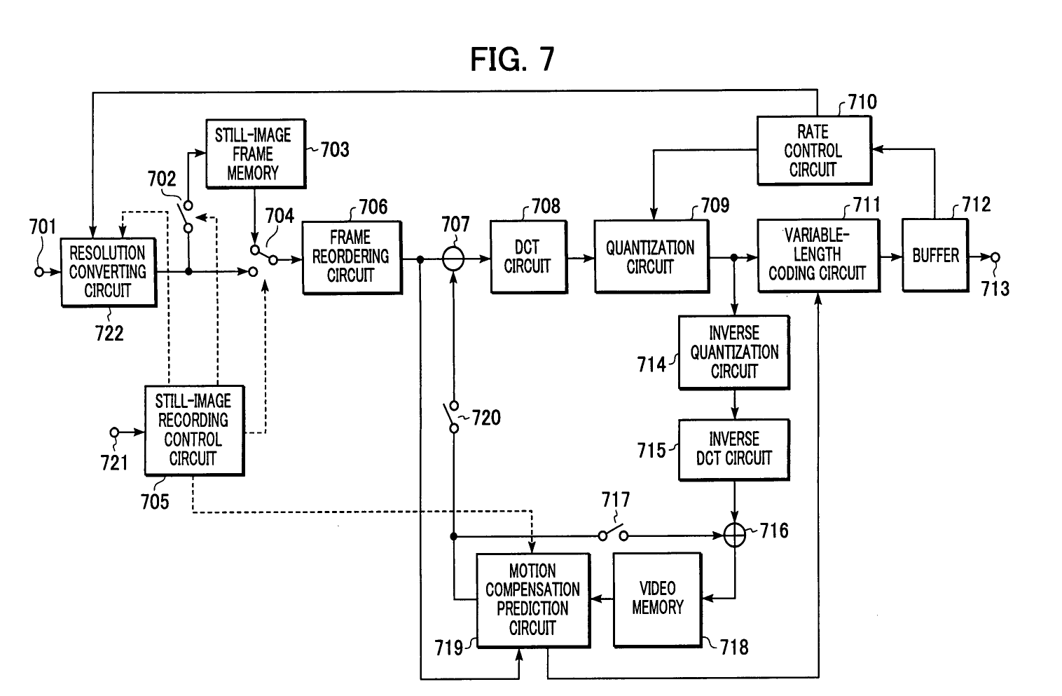

FIG. 7 shows an MPEG compression encoder circuit according to a third embodiment of the present invention having a different structure from the structure described above. The compression encoder circuit shown in FIG. 7 can be used as the compression encoder circuit 103 of the digital video recorder shown in FIG. 1.

In FIG. 7, digital image data input to a terminal 701 is supplied to a resolution converting circuit 722. In the resolution converting circuit 722, the input image data is subjected to band limitation using a spatial filter and is further subjected to resolution conversion by resampling when, based on the feedback from a rate control circuit 710, the amount of coding is over a predetermined threshold value and quality degradation caused by quantization is noticeable, thereby limiting high-frequency components and reducing the number of pixels of the input image.

The motion-picture data whose resolution is converted is supplied to one input terminal of a switch 704. When still-image data is input, the still-image data is stored in a still-image frame memory 703 via a still-image hold switch 702, which operates in accordance with an instruction for still image recording, and is then supplied to the other input terminal of the switch 704.

The motion-picture data input from the switch 704 is supplied to a frame reordering circuit 706, where frames of the motion-picture data are rearranged according to the MPEG coding order.

A frame difference circuit 707 takes the difference from inter-frame predicted data for the P-pictures and B-pictures via a switch 720.

A DCT circuit 708 converts the source image for the I-picture, and the prediction error image for the P-pictures and B-pictures into DCT coefficients.

A quantization circuit 709 performs quantization based on the product of a quantization matrix and a quantization characteristic value Q fed back from the rate control circuit 710. The quantized coefficients are entropy-coded by a variable-length coding circuit 711. The resulting values are passed through a buffer 712 for rate control, and are output from a terminal 713.

An inverse quantization circuit 714 inversely quantizes the quantized coefficients. The resulting values are converted into pixel values by an inverse DCT circuit 715, and are added to the predicted images for the P-pictures and B-pictures by a frame adding circuit 716, by controlling a switch 717. The resulting image is stored in a video memory 718 as a local decoded image.

The image stored in the video memory 718 is converted by a motion compensation prediction circuit 719 into a predictive image subjected to motion compensation with an input image to be predicted. This image is the predicted data for the P-pictures and B-pictures used in the frame difference circuit 707.

When a control signal for still image recording is input to a terminal 721, a still-image recording control circuit 705 turns on the switch 702 to capture the digital image data in the still-image frame memory 703, and further connects the switch 704 to the still-image frame memory 703 for a predetermined period of time, to input the same still-image frames read from the still-image frame memory 703 to the frame reordering circuit 706, and the following MPEG coding loop continuously for the predetermined period of time.

The MPEG coding process is carried out on both still-image data and motion-picture data in a similar way; however, the following control is performed for still-image data.

First, the still-image recording control circuit 705 controls the motion compensation prediction circuit 719 so that motion compensation deliberately is not performed for still image recording, to suppress or prohibit the occurrence of motion vectors (the motion vector is zero). This prevents an increased amount of coding due to unnecessary motion vectors between the inter-frame predicted image and the source image caused by a coding error even when the same frames are input.

The still-image recording control circuit 705 also controls the resolution converting circuit 722 so as to suppress or prohibit resolution conversion, which is performed for motion picture recording, when the still-image data is recorded to maintain the resolution higher than a reference. Thus, if the horizontal resolution is reduced to one half for motion picture recording, the original resolution of the still images can be maintained when they are recorded. In addition, it is expected that the increased amount of coding experienced with still image recording can be cancelled out by high-efficiency coding of the B-pictures and P-pictures.

Fourth Embodiment

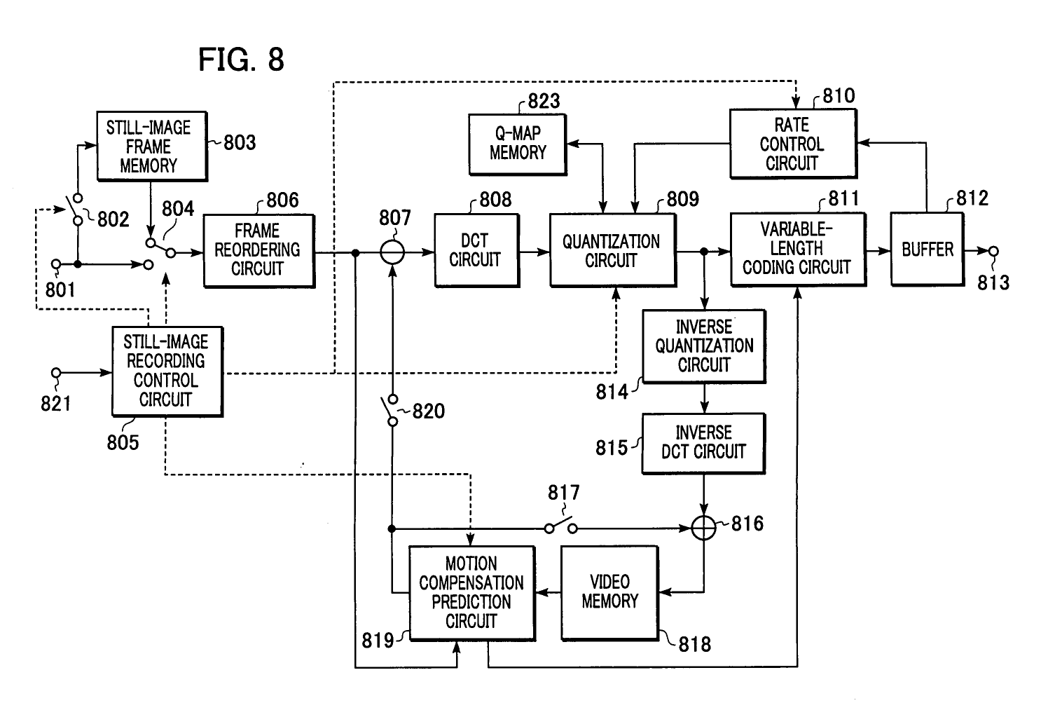

FIG. 8 shows an MPEG compression encoder circuit according to a fourth embodiment of the present invention having a different structure from the structure described above. The compression encoder circuit shown in FIG. 8 can be used as the compression encoder circuit 103 of the digital video recorder shown in FIG. 1.

In FIG. 8, digital image data input to a terminal 801 may be motion-picture data or still-image data. The motion-picture data is supplied to one input terminal of a switch 804. The still-image data is stored in a still-image frame memory 803 via a still-image hold switch 802, which operates in accordance with an instruction for still image recording, and is then supplied to the other input terminal of the switch 804.

The motion-picture data input from the switch 804 is supplied to a frame reordering circuit 806, where frames of the motion-picture data are rearranged according to the MPEG coding order.

A frame difference circuit 807 takes the difference from inter-frame predicted data for the P-pictures and B-pictures via a switch 820.

A DCT circuit 808 converts the source image for the I-picture, and the prediction error image for the P-pictures and B-pictures into DCT coefficients.

A quantization circuit 809 performs quantization based on the product of a quantization matrix and a quantization characteristic value Q fed back from a rate control circuit 810. The quantized coefficients are entropy-coded by a variable-length coding circuit 811. The resulting values are passed through a buffer 812 for rate control, and are output from a terminal 813.

An inverse quantization circuit 814 inversely quantizes the quantized coefficients. The resulting values are converted into pixel values by an inverse DCT circuit 815, and are added to the predicted images for the P-pictures and B-pictures by a frame adding circuit 816 by controlling a switch 817. The resulting image is stored in a video memory 818 as a locally decoded image.

The image stored in the video memory 818 is converted by a motion compensation prediction circuit 819 into a predictive image subjected to motion compensation with an input image to be predicted. This image is the predicted data for the P-pictures and B-pictures used in the frame difference circuit 807.

When a control signal for still image recording is input to a terminal 821, a still-image recording control circuit 805 turns on the switch 802 so as to capture the digital image data in the still-image frame memory 803, and further connects the switch 804 to the still-image frame memory 803 for a predetermined period of time, to input the same still-image frames read from the still-image frame memory 803 to the frame reordering circuit 806 and the following MPEG coding loop continuously for the predetermined period of time.

The MPEG coding process is carried out on both still-image data and motion-picture data in a similar way; however, the following control is performed for still-image data.

First, the still-image recording control circuit 805 controls the motion compensation prediction circuit 819 so that motion compensation deliberately is not performed for still image recording, to suppress or prohibit the occurrence of motion vectors (the motion vector is zero). This prevents an increased amount of coding due to unnecessary motion vectors between the inter-frame predicted image and the source image caused by a coding error even when the same frames are input.

The still-image recording control circuit 805 also controls the quantization circuit 809 and the rate control circuit 810 so that a quantization characteristic value Q stored in a Q-map memory 823 is used and the quantization characteristic value Q is fixed for each picture in the same still-image frame during still image recording.

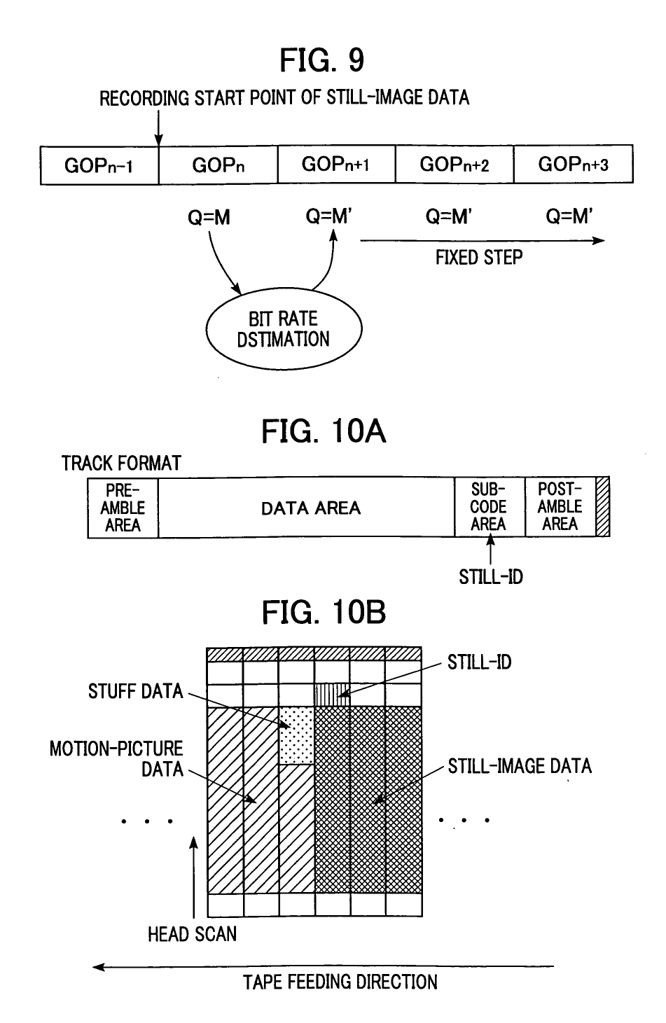

FIG. 9 shows the operation with the quantization characteristic value Q fixed. At a recording start point of still-image data (GOPn), the quantization characteristic value Q of each picture in the still-image sequence is determined for each macroblock. The quantization characteristic value Q may be determined by a standard rate control sequence, or may be the converted one for still-image data described above.

After coding the GOPn, the subsequent still-image sequences to be coded are the same digital data. Thus, the optimum quantization characteristic value Q for the subsequent same still-image sequences can be estimated from the coded bit rate. The macroblock map of the estimated value Q for each picture is indicated by M′.

The Q-map memory 823 holds the Q-map M′ estimated for the still-image sequences for a duration of continuously recording the same still-image sequences, and quantization for the subsequent GOPs is performed using the Q-map M′. This overcomes a drawback that the image quality of the same still images changes over time.

Other Embodiments

The present invention also encompasses a mechanism in which program code of software for implementing the functions of the foregoing preferred embodiments is installed in a computer (CPU or MPU) built in an apparatus or a system to operate various devices connected therewith according to a program stored in the computer of the apparatus or system, thereby realizing the functions of the foregoing preferred embodiments.

In this case, the software program code realizes the functions of the foregoing preferred embodiments, and the program code itself constitutes an embodiment of the present invention. Transmission media of the program code may include communication media (including wired communication, such as optical fiber, and wireless communication) in a computer network (such as a LAN, a WAN such as the Internet, or a wireless communication network) system for providing the program information by propagating it on carrier waves.

Media for providing program code for a computer, such as recording media having the program code stored therein, also constitutes a preferred embodiment of the present invention. The recording media having the program code stored therein may include, for example, a flexible disk, a hard disk, an optical disk, a magneto-optical disk, a CD-ROM, a magnetic tape, a non-volatile memory card, a ROM, or the like.

It is to be understood that the present invention also encompasses a case where a computer executes program code supplied thereto to realize the functions of the foregoing preferred embodiments, and a case where the program code cooperates with an OS (operating system) or other application software running on the computer to thereby realize the functions of the foregoing preferred embodiments.

It is also to be understood that the present invention also encompasses a case where program code supplied thereto is stored in a memory of a function extension board of a computer or a function extension unit connected to the computer, after which a CPU or the like of the function extension board or function extension unit executes a portion of or the entirety of the actual processing according to an instruction of the program code, to thereby realize the functions of the foregoing preferred embodiments.

The configuration and structure of the various parts and elements shown in the foregoing preferred embodiments are merely specific examples of the present invention, and the technical scope of the present invention is not limited thereto. A variety of modifications may be made without departing from the spirit or scope of the present invention.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image processing apparatus for compressing input image data and outputting the compressed data, said image processing apparatus comprising:
a memory that stores input still-image data and outputs the stored still-image data continuously for a predetermined period of time;
compressing means for compressing input motion-picture data, or the still-image data output from said memory continuously for the predetermined period of time, using the same compression technique; and
control means for controlling said compressing means so as to compress the motion-picture data and the still-image data by different quantization processes.

2. An image processing apparatus according to claim 1, wherein said compressing means performs at least inter-frame coding.

3. An image processing apparatus according to claim 2, wherein said control means controls said compressing means so that a smaller quantization step is used to compress the still-image data than the quantization step used to compress the motion-picture data.

4. An image processing apparatus according to claim 2, wherein said compressing means includes quantization means for performing quantization based on the product of a quantization matrix and a quantization characteristic value.

5. An image processing apparatus according to claim 4, wherein said quantization means quantizes the still-image data using a quantization characteristic value having a smaller step than the step of a quantization characteristic value used to quantize the motion-picture data.

6. An image processing apparatus according to claim 4, wherein said quantization means quantizes the still-image data using a quantization matrix different from a quantization matrix used to quantize the motion-picture data.

7. An image processing apparatus according to claim 2, further comprising motion compensation prediction means for performing motion compensation prediction for inter-frame coding,
wherein, when the still-image data is compressed, said control means controls the motion compensation prediction means so as to suppress or prohibit the occurrence of motion vectors for motion compensation prediction.

8. An image processing apparatus according to claim 1, further comprising:
recording means for recording the motion-picture data or still-image data compressed by said compressing means; and
identification information adding means for adding identification information for identifying the still-image data to the recorded still-image data when the compressed still-image data is recorded in said recording means.

9. An image processing apparatus according to claim 8, further comprising instructing means for instructing still image recording, wherein said control means, said identification information adding means, and said recording means perform a still image recording operation according to an instruction from said instructing means.

10. An image processing apparatus for compressing input image data and outputting the compressed data, said image processing apparatus comprising:
a memory that stores input still-image data and outputs the stored still-image data continuously for a predetermined period of time;
compressing means for compressing input motion-picture data, or the still-image data output from said memory continuously for the predetermined period of time, using at least an inter-frame coding compression technique; and
control means for controlling a direction of prediction of the inter-frame coding in said compressing means when the still-image data is compressed.

11. An image processing apparatus according to claim 10, wherein, when the still-image data is compressed, said control means controls said compressing means so that a frame coding unit at which processing of the still-image data starts is not predicted from an immediately preceding frame coding unit.

12. An image processing apparatus according to claim 11, further comprising motion compensation prediction means for performing motion compensation prediction of inter-frame coding,
wherein the still-image data has a frame structure, and frame prediction is performed.

13. An image processing apparatus for compressing input image data and outputting the compressed data, said image processing apparatus comprising:
resolution converting means for converting a resolution of the input image data;
a memory that stores still-image data output from said resolution converting means and outputs the stored still-image data continuously for a predetermined period of time;
compressing means for compressing motion-picture data output from said resolution converting means, or the still-image data output from said memory continuously for the predetermined period of time, using at least an inter-frame coding compression technique; and
control means for activating said resolution converting means when the motion-picture data is compressed, and for deactivating or suppressing the operation of said resolution converting means when the still-image data is compressed.

14. An image processing apparatus according to claim 13, further comprising motion compensation prediction means for performing motion compensation prediction for inter-frame coding,
wherein said control means controls said motion compensation prediction means so as to suppress or prohibit the occurrence of motion vectors for motion compensation prediction when the still-image data is compressed.

15. An image processing apparatus for compressing input image data and outputting the compressed data, said image processing apparatus comprising:
a memory that stores input still-image data and outputs the stored still-image data continuously for a predetermined period of time;
compressing means for compressing input motion-picture data, or the still-image data output from said memory continuously for the predetermined period of time, using at least an inter-frame coding compression technique; and
control means for controlling said compressing means so as to compress the motion-picture data and the still-image data by different operations,
wherein said compressing means includes quantization means, and said control means controls said compressing means so that said quantization means uses a variable quantization characteristic value when the motion-picture data is compressed and uses a constant quantization characteristic value when the still-image data is compressed.

16. An image processing apparatus according to claim 15, further comprising a memory that stores the quantization characteristic value used to compress the still-image data.

17. An image processing apparatus according to claim 15, further comprising motion compensation prediction means for performing motion compensation prediction for inter-frame coding,
wherein said control means controls said motion compensation prediction means so as to suppress or prohibit the occurrence of motion vectors for motion compensation prediction when the still-image data is compressed.

18. A recording apparatus for compressing input image data and recording the compressed data, said recording apparatus comprising:
a memory that stores input still-image data and outputs the stored still-image data continuously for a predetermined period of time;
compressing means for compressing input motion-picture data, or the still-image data output from said memory continuously for the predetermined period of time, using at least an inter-frame coding compression technique;
recording means for recording the motion-picture data or still-image data compressed by said compressing means; and
control means for controlling said compressing means so as to perform different compression operations, and controlling said recording means so as to perform different recording operations when the motion-picture data is recorded and when the still-image data is recorded.

19. An image processing apparatus according to claim 18, further comprising identification information generating means for generating identification information for identifying the still-image data when the still-image data is recorded.

20. An image processing apparatus according to claim 19, wherein said control means controls said recording means so as to record the compressed motion-picture data when the motion-picture data is recorded, and controls said recording means so as to record the compressed still-image data and the identification information generated by said identification information generating means when the still-image data is recorded.

21. An image processing apparatus according to claim 19, further comprising instructing means for instructing still image recording,
wherein said control means, said identification information generating means, and said recording means perform a still image recording operation according to an instruction from said instructing means.

22. An image processing apparatus according to claim 18, wherein said compressing means includes quantization means for performing quantization based on the product of a quantization matrix and a quantization characteristic value.

23. An image processing apparatus according to claim 22, wherein said quantization means quantizes the still-image data using a quantization characteristic value having a smaller step than the step of a quantization characteristic value used to quantize the motion-picture data.

24. An image processing apparatus according to claim 23, wherein said quantization means quantizes the still-image data using a quantization matrix different from a quantization matrix used to quantize the motion-picture data.

25. An image processing apparatus according to claim 18, further comprising motion compensation prediction means for performing motion compensation prediction for inter-frame coding,
wherein said control means controls said motion compensation prediction means to suppress or prohibit the occurrence of motion vectors for motion compensation prediction when the still-image data is compressed.
